(19) United States
(12) Patent Application Publication
(10) Pub. No.: US 2024/0063438 A1
(43) Pub. Date: Feb. 22, 2024

(54) Rechargeable Battery

(71) Applicant: SES Holdings Pte. Ltd., Singapore (SG)

(72) Inventors: Younggyu Nam, Boston, MA (US); Bin Liu, Lexington, MA (US); Zi Wei, Woburn, MA (US); Winston Wang, Shanghai (CN); Heekyung Lee, Winchester, MA (US); KwangChun Kim, North Andover, MA (US)

(21) Appl. No.: 18/267,279

(22) PCT Filed: Dec. 15, 2021
(86) PCT No.: PCT/IB2021/061797

§ 371 Date: Jun. 14, 2023

Related U.S. Application Data
(60) Provisional application No. 63/125,821, filed on Dec. 15, 2020.

(51) Int. Cl. H01M 10/0569; H01M 10/052; H01M 10/0568; H01M 4/131

(52) U.S. Cl. CPC H01M 10/0569; H01M 10/052; H01M 10/0568; H01M 4/131; H01M 2004/028

(57) ABSTRACT

Battery core packs employing specific electrolyte solutions and minimum cell-face pressures and methods are disclosed for minimizing dendrite growth and increasing cycle life of metal and metal-ion battery cells.

### RELATED APPLICATION DATA

This application claims the benefit of priority of U.S. Provisional Patent Application Ser. No. 63/125,821, filed Dec. 15, 2020, and titled “Rechargeable Battery”, which is incorporated by reference herein in its entirety.

### FIELD OF THE DISCLOSURE

The present disclosure generally relates to rechargeable batteries. In particular, the present disclosure is directed to a battery core pack comprised of a plurality of cells.

### BACKGROUND

A general structure of a lithium metal battery cell includes a lithium metal anode bonded to a copper current collector and a metal oxide cathode bonded to an aluminum current collector. Between the anode and cathode is a separator that allows lithium metal ions to move back and forth. A variety of different electrolyte solutions may be used between the cathode and anode. When a battery of this type discharges, lithium metal ions are stripped from the anode and travel to the cathode through the separator. During charging, the ion flow is reversed and the metal ions are re-plated back onto the anode. However, as is well-known in the art, the re-plating of Li metal is often not uniform, resulting in the formation of dendrites extending out from the anode surface after a few discharge/charge cycles. If left uncontrolled, dendrite growth may pierce the separator and cause a short of the cell after a relatively few cycles. The battery is greatly degraded when this happens.

The plating and striping of metal ions from the anode also cause individual cells to contract and then expand as the metal ions are stripped and then re-plated. Other battery types, for example lithium-ion batteries that use graphite or Si graphite anodes, also function based on ion stripping and re-plating and thus may undergo significant volume expansion and experience problematic dendrite growth on re-plating.

Many attempts have been made to mitigate the problems associated with dendrite growth. For example, U.S. Pat. No. 6,087,036, entitled “Thermal Management System and Method for a Solid-State Energy Storing Device” discloses cell structures employing lithium metal anodes and vanadium oxide cathodes with non-specific lithium polymer electrolytes. According to this disclosure, application of constant or varying compressive forces to the cells in the range of 5-100 psi, along with active cooling can provide improved results by constraining and cooling the cell structures. As another example, U.S. Patent Publication No. 2020/0220220 A1, entitled “Electrolytes with Lithium Difluoro(oxalato)borate and Lithium Tetrafluoroborate Salts for Lithium Metal and Anode-Free Cells” discloses results of experiments in which increased cycle life was claimed using anode-free cells with an electrolyte having a salt combination of lithium difluoro(oxalato)borate (LiDFOB) and lithium tetrafluoroborate (LiBF₄) and a solvent combination of diethyl carbonate (DEC) and fluorethylene carbonate (FEC). Varying cell pressures are mentioned, however, the experimental results were primarily achieved with pressures at 100 psi or less. Also, U.S. Patent Publication No. 2021/0151815 A1, entitled “Electrochemical Cell Stacks and Associated Components” discloses cells including a thermal insulating layer and a thermal conducting layer under pressures ranging from at least 10 kgf/cm² (about 140 psi) and to at least 40 kgf/cm² (about 570 psi). This disclosure claims improved results, but provides no details on electrolyte salts or solvents that might be used to achieve the claimed improvements.

Thus, in spite of the many attempts at improvements, as evidenced by the references cited above, current techniques for the control of the dendrite growth, in particular in lithium metal batteries, remain less than satisfactory. New solutions are needed to extend battery life cycles.

### SUMMARY OF THE DISCLOSURE

In one implementation, the present disclosure is directed to a battery core pack that includes a plurality of cells forming a cell stack, each cell comprising at least one anode and at least one cathode, wherein metal ions are stripped from the anode during discharge and re-plated on the anode during charge; and a containment structure at least partially surrounding the cell stack, wherein the containment structure imparts a substantially uniform surface pressure on the cell stack of at least about 100 psi.

In yet another implementation, the present disclosure is directed to a method of controlling dendrite growth on the anode of a metal or metal-ion battery cell, wherein the cell comprises at least one planar anode and at least one planar cathode and wherein material is stripped from the anode during cell discharge and re-plated on the anode during cell charge. The method includes assembling plural cells into a cell stack; positioning the cell stack within a containment structure, the containment structure at least partially surrounding the cell stack; and applying and maintaining a substantially uniform minimum surface pressure of at least about 100 psi across the cells of the cell stack with the containment structure.

In some embodiments, in addition to being substantially uniform, the surface pressure on the cell stack is maintained as a substantially constant pressure. In other embodiments, the substantially uniform and constant pressure is within the range of about 100-500 psi and in other embodiments more preferably within a range of about 200-300 psi.

In another implementation, the present disclosure is directed to a battery core pack, which includes a plurality of cells forming a cell stack, each cell comprising at least one anode and at least one cathode, wherein metal ions are stripped from the anode during discharge and re-plated on the anode during charge; and a containment structure at least partially surrounding the cell stack, wherein the containment structure imparts an at least substantially uniform and constant surface pressure of at least 200 psi to the cells of the cell stack.

In still another implementation, the present disclosure is directed to a battery core pack, which includes a cell stack comprised of at least four cells with a core pack energy density of at least about 590 Wh/L at 30% SoC and a discharge capacity of greater than 2.5 Ah over at least 100 charge/discharge cycles, each the cell having a load level of about 25 mg/cm² and to about 31 mg/cm², and comprising at least one cathode formed as a layered or spinel oxide material of the general formula of LixMyOz, where M is a transition metal comprising Co, Mn, Ni, V, Fe, or Cr, and at least one lithium metal anode having a thickness in the range of 10 μm-100 μm in the discharged state; an electrolyte contained in each the cell comprising one or more lithium salts selected from the group consisting of: lithium bis(fluorosulfonyl)imide, lithium bis(trifluoromethane-sulfonyl)imide, lithium hexafluorophosphate, lithium bis(oxalato)borate, lithium difluoro(oxalato)borate, lithium perchlorate, and lithium tetrafluoroborate, wherein the lithium salt is present in a concentration range from 0.1 M to 8.0 M; and a containment structure at least partially surrounding the cell stack, wherein the containment structure imparts an at least substantially uniform and constant surface pressure within a range of about 200 psi to about 300 psi to the cells of the cell stack.

In yet another implementation, the present disclosure is directed to a battery core pack, which includes a plurality of cells forming a cell stack, each cell comprising at least one anode, at least one lithium containing cathode, and an electrolyte comprising one or more lithium salts with a concentration range from 0.1 M to 8.0 M including at least lithium bis(fluorosulfonyl)imide in combination with one or more solvents selected from the group consisting of ethylmethyl carbonate, fluoroethylene carbonate, 1,2-diethoxy ethane, 1,2-(1,1,2,2-tetrafluoroethoxy)ethane, 1,4-dioxane and dimethylsulfamoyl fluoride; and a containment structure at least partially surrounding the cell stack, wherein the containment structure imparts an at least substantially uniform and constant surface pressure of at least 200 psi to the cells of the cell stack.

In still yet another implementation, the present disclosure is directed to a method of controlling dendrite growth on the anode of a metal or metal-ion battery cell, wherein the cell comprises at least one planar anode and at least one planar cathode and wherein material is stripped from the anode during cell discharge and re-plated on the anode during cell charge. The method includes assembling plural cells into a cell stack; positioning the cell stack within a containment structure, the containment structure at least partially surrounding the cell stack; and applying and maintaining a substantially uniform minimum surface pressure of at least about 200 psi across the cells of the cell stack with the containment structure.

### BRIEF DESCRIPTION OF THE DRAWINGS

For the purpose of illustrating the disclosure, the drawings show aspects of one or more embodiments. However, it should be understood that the present disclosure is not limited to the precise arrangements and instrumentalities shown in the drawings, wherein:

FIG. 1 is perspective view of an embodiment of a constant pressure battery device according to the present disclosure;

FIG. 2 is a schematic cross-sectional view of a battery cell as may be used in embodiments of the present disclosure;

FIG. 3 presents perspective views of two different embodiments of constant force springs for use in methods and apparatus disclosed herein;

FIG. 4 is a plot of battery discharge capacity versus cycle life over a range of constant cell-face pressures for embodiments of the present disclosure;

FIGS. 5A and 5B are plots of battery discharge capacity versus cycle life at load levels of 25 mg/cm² and 31 mg/cm², respectively;

FIG. 6 is a perspective view of another alternative embodiment of the present disclosure;

FIG. 7 is an exploded perspective view of the embodiment of FIG. 6; and

FIG. 8 is a longitudinal cross-section view of the embodiment shown in FIGS. 6 and 7;

### DETAILED DESCRIPTION

Lithium dendrite growth on the lithium metal anode surface in lithium metal batteries has been known to result in short circuits and general degradation of cell performance. These negative effects can arise after relatively few discharge/charge cycles. This disclosure presents, among other things, cell-face pressure control techniques that provide more uniform lithium plating and stripping and suppress dendritic lithium growth to extend the life of the battery. In one embodiment, a substantially uniform, constant pressure, mechanically constrained system for single or multiple cells in a module or battery pack is provided. While the present disclosure is exemplified with lithium metal cells, as will be appreciated by persons of ordinary skill, the teachings contained herein with respect to techniques for encouraging more uniform plating and stripping, and suppressing dendritic anode surface growth are also applicable to other metal and metal-ion battery types.

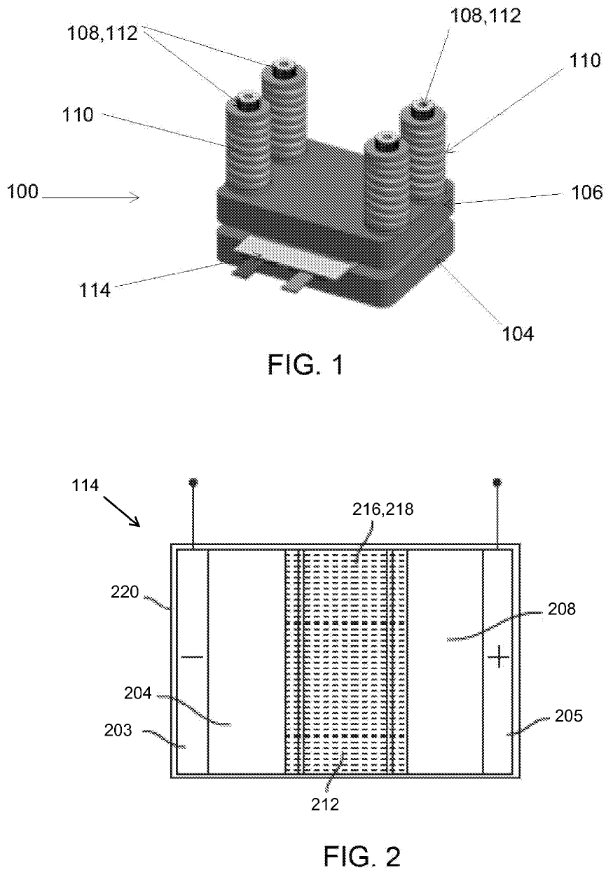

In one embodiment, as illustrated in FIG. 1, housing structure 100 applies a uniform and constant pressure to one or more cells 114 such that the pressure is maintained uniformly across the surface of the cells and with little to no variation in pressure over the cell charge/discharge cycle. In general, the uniform constant cell surface pressure should be maintained above at least about 200 psi. In some embodiments, the uniform and substantially constant pressure applied will be a pressure between about 200 psi and 300 psi.

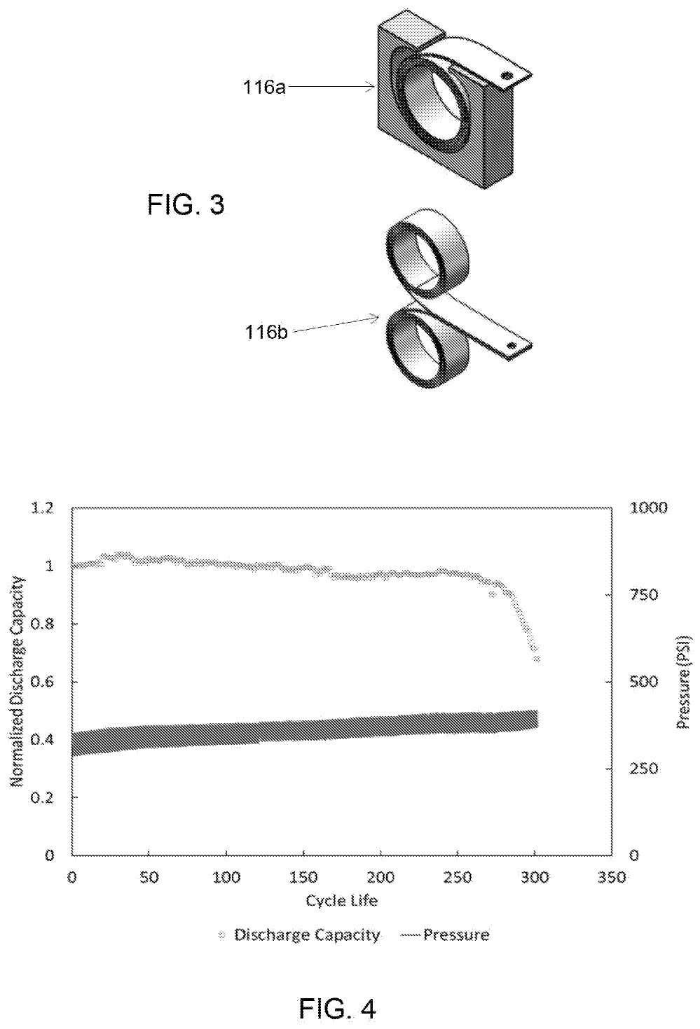

Housing structure 100 comprises two parallel metal plates 104, 106 that sandwich the one or more battery cells 114 between them. Four metal shafts 108 are positioned in the four corners of the housing structure. Metal shafts 108 are secured to bottom plate 104 oriented perpendicularly to the plates and pass through aligned holes in top plate 106 with a tight sliding fit to form guide posts to maintain parallelism between the two plates. In one embodiment, springs 110 are situated over the shafts and adjusted to apply uniform, at least substantially pressure. A spring fixing system 112 that permits the applied pressure to be adjusted by tightening or loosening of the spring fixing system is provide. In preferred embodiments, the springs are selected that provide a linear pressure profile over a range of distance. Alternatively, constant force tension springs 116a, 116b, such as shown in FIG. 3 may be arranged to draw the two plates together by applying constant force over the anticipated range of the expansion and contraction of the cells between the plates.

FIG. 2 schematically illustrates an example cell 114 as used in embodiments disclosed herein. FIG. 2 illustrates only some basic functional components of a cell 114. A real-world instantiation of the cell will typically be embodied using either a wound or stacked construction including other components, such as electrical terminals, seal(s), thermal shutdown layer(s), and/or vent(s), among other things, that, for ease of illustration, are not shown in FIG. 2. In the illustrated example, cell 114 includes a spaced-apart cathode 208 and anode 204, and a pair of corresponding respective current collectors 203, 205. A dielectric separator 212 is located between the cathode and anode 208, 204 to electrically separate the cathode and anode but to allow lithium ions, ions of electrolyte 216, including specially formulated additives which assist in inhibiting dendrite growth in combination with the application of uniform and at least substantially constant pressure as described above. The separator may be porous. The separator 212 and/or one, the other, or both of cathode 208 and anode 204 may also be impregnated with electrolyte 216, including its additives. The cell 114 includes a container 220 that contains the current collectors 203, 205, cathode 208, anode 204, separator 212, and electrolyte 216.

In the formation of electrolyte 216, solvents can be used, such as linear carbonates (dimethyl carbonate, diethyl carbonate, ethylmethyl carbonate); cyclic carbonates (ethylene carbonate, propylene carbonate, fluoroethylene carbonate, vinylene carbonate); linear ethers (methyl propyl ether, methyl butyl ether, ethyl propyl ether, ethyl butyl ether, propyl butyl ether, diethyl ether, dipropyl ether, and dibutyl ether, 1,2-diethoxy ethane, 1,2-dimethoxy ethane, 1,2-dipropoxyethane, and 1,2-dibutoxyethane, bis(2-methoxyethyl) ether, 2-ethoxyethyl ether, 1,2-(1,1,2,2-tetrafluoroethoxy)ethane, and 1,1,2,2-tetrafluoroethyl 2,2,3,3-tetrafluoropropyl ether); cyclic ethers (1,3-dioxolane, 1,4-dioxane, 1,3-dioxane, tetrahydropyran, tetrahydrofuran, 2,4-dimethyltetrahydrofuran, 2-methyltetrahydrofuran, 3-methyltetrahydrofuran, 2-ethyl-5-methyltetrahydrofuran); esters (methyl formate, ethyl formate, methyl acetate, ethyl acetate); sulfonyl (N,N-dimethylsulfamoyl fluoride); and phosphate (triethyl phosphate). Each electrolyte may contain a single solvent or a mixture of two or more solvents, each solvent ranging from 100% to 0.2% by volume or by weight or by mole ratios. In some examples in may be more preferable if the range of each solvent from 100% to 30% by volume or by weight or by mole ratios.

Further, lithium salts can be combined with the above solvents, such as: lithium bis(fluorosulfonyl)imide, lithium bis(trifluoromethanesulfonyl)imide, lithium hexafluorophosphate, lithium bis(oxalato)borate, lithium difluoro(oxalato)borate, lithium perchlorate, lithium tetrafluoroborate. Either single salt or multiple salts can be used with a concentration range from 0.1 M to 8.0 M. In some embodiments, a lithium salt concentration range from 1.5 M to 4.5 M is preferable.

The following are illustrative examples of formulations for electrolyte 216:
Electrolyte Example A: salt is lithium bis(fluorosulfonyl)imide, solvent mixture is ethylmethyl carbonate and fluoroethylene carbonate, the electrolyte formulation is 2 M Lithium bis(fluorosulfonyl)imide in ethylmethyl carbonate and fluoroethylene carbonate in a volume ratio of 70:30.
Electrolyte Example B: salt is lithium bis(fluorosulfonyl)imide, solvent mixture is 1,2-diethoxy ethane and 1,2-(1,1,2,2-tetrafluoroethoxy)ethane, the electrolyte formulation is 3.6 M lithium bis(fluorosulfonyl)imide in 1,2-diethoxy ethane (60 vol %) with 1,2-(1,1,2,2-Tetrafluoroethoxy)ethane (40 vol %).
Electrolyte Example C: salt is lithium bis(fluorosulfonyl)imide, solvent mixture is 1,4-dioxane, 1,2-diethoxy ethane, and 1,2-(1,1,2,2-tetrafluoroethoxy)ethane, the electrolyte formulation is 4.09 M lithium bis(fluorosulfonyl)imide in 1,4-dioxane and 1,2-diethoxy ethane in volume ratio of 21.7%: 78.3% (70 vol %) with 1,2-(1,1,2,2-tetrafluoroethoxy)ethane (30 vol %).
Electrolyte Example D: salt is lithium bis(fluorosulfonyl)imide, solvent is dimethylsulfamoyl fluoride, the electrolyte formulation is 2.5 M lithium bis(fluorosulfonyl)imide in dimethylsulfamoyl fluoride (100 vol %).

Electrolyte 216 may include additives such as a redox shuttling additive, which may be any of a variety of redox shuttling additives known in the art. Examples of suitable redox shuttling additives include 2,5-Di-tert-butyl-1,4-bis(2-methoxyethoxy)benzene (DBBB), 2,5-Di-tert-butyl-1,4-bis(methoxy)benzene (DDB), 2,5-Di-tert-butyl-1,4-bis(2,2,2-trifluoroethoxy)benzene (DBDFB), 2,5-Di-tert-butyl-1,4-bis(2,2,3,3-tetrafluoropropyloxy)benzene (DBTFP), 2,5-Di-tert-butyl-1,4-bis(4,4,4,3,2,2-hexafluorobutyloxy)benzene (DBHFB), 2,7-diacetylthiathrene, 2,7-dibromthianthrene, 2,7-diisobutanoylthianthrene, 2-acetylthianthrene, 2,5-difluoro-1,4-dimethoxybenzene (DFDB), 2-(pentafluorophenyl)-tetrafluoro-1,3,2-benzodioxaborole, Li2B12F12, tetraethyl-2,5-di-tert-butyl-1,4-phenylene diphosphate (TEDBPDP), 1,4-bis[bis(1-methylethyl)phosphinyl]-2,5-dimethoxylbenzene (BPDB), 1,4-bis[bis(1-methyl)phosphinyl]-2,5-difluoro-3,6-dimethyoxylbenzene (BPDFDB), pentafluorophenyl-tetrafluorobenzyl-1,2-dioxoborone (PFPTFBDB), ferrocene and their derivatives, phenothiazine derivatives, N,N-dialkyl-dihydrophenazine, 2,2,6,6-tetramethylpiperinyloxide (TEMPO), Li₂B₁₂H₁₂₋ₓFₓ (x=9 and 12).

The cathode and anode 208, 204 may comprise a variety of different structures and materials compatible with lithium-metal ions and electrolyte 216. Each of the current collectors 203, 205 may be made of any suitable electrically conducting material, such as copper or aluminum, or any combination thereof. The separator 212 may be made of any suitable porous dielectric material, such as a porous polymer, among others.

The cathode 208 may be formed from a variety of materials such as a material of the general formula of LiₓM_{y}O_{z}, where M is a transition metal such as Co, Mn, Ni, V, Fe, or Cr, and x, y, z are chosen to satisfy valence requirements. In one or more embodiments, the cathode is a layered or spinel oxide material selected from the group comprising of LiCoO₂, Li(Ni_{1/3}Mn_{1/3}Co_{1/3})O₂, Li(Ni_{0.8}Co_{0.15}Al_{0.05})O₂, LiMn₂O₄, Li(Mn_{1.5}Ni_{0.5})₂O₄, or their lithium rich versions. In one or more embodiments, the cathode material is LiCoO₂ (charged to 4.4V vs. Li metal), NCA or NCM (622, 811) (charged to 4.30V vs. Li metal).

The anode 204 may be a thin lithium metal anode that, in the discharged state has a thickness in the range of 10 μm-100 μm, or 20 μm-80 μm, or 40 μm-60 μm. Although FIG. 2 schematically shows anode 204 adjacent current collector 203, the anode material, e.g., sheets or films of lithium metal, may be disposed on both sides of the current collector. In another example, the cell 114 may have an anode-less design, where the cell simply includes the anode current collector 203 and the cathode 208. The lithium ions are deposited on the anode current collector 203 during initial cell charging to form lithium anode 204. Further information regarding example materials and constructions of the cell 114 can be found in PCT publication number WO 2017/214276, titled, “High energy density, high power density, high capacity, and room temperature capable ‘anode-free’ rechargeable batteries,” which is incorporated by reference herein in its entirety.

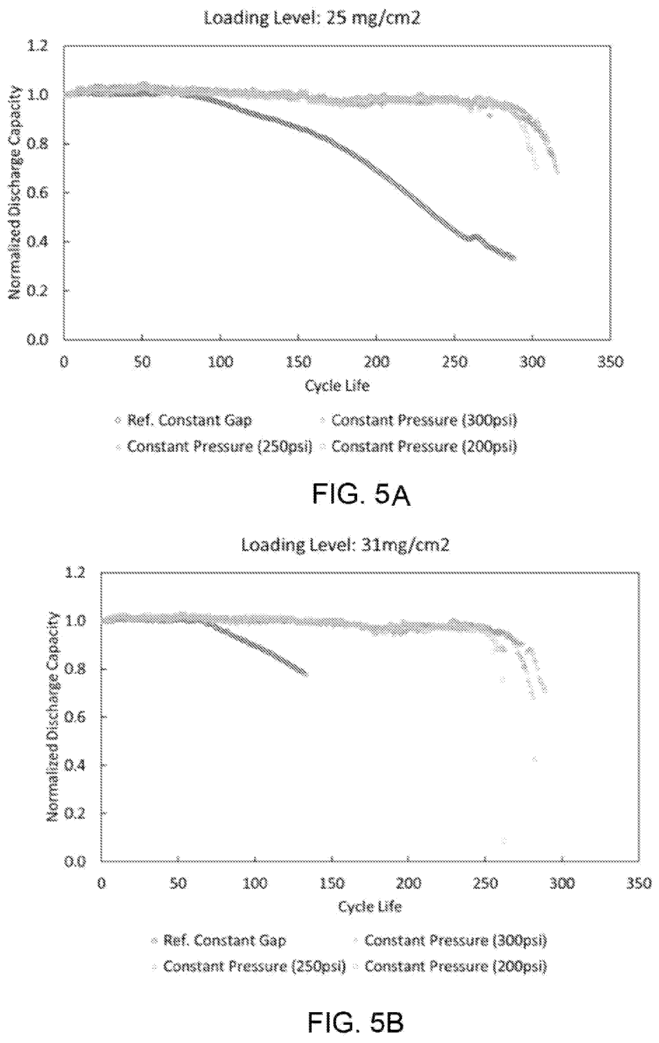

FIG. 4 shows the discharge capacity versus cycle life for cells as disclosed herein when the cell is placed under uniform, at least substantially constant pressure. The pressure is uniformly applied to both surfaces of the cell. It is shown that the dendrite growth is well constrained, and the number of the cycle life changes slightly when the applied pressure is within the ranges specified above. Thus, in order to obtain a larger number of cycle life, the pressure applied to the surfaces of each cell above at least 200 psi is a critical pressure to control the dendrite growth. With substantially uniform pressure applied to both surfaces of the cell at or above the critical pressure, the cycle life of the cell is improved, indicating that the dendrite growth is effectively suppressed by the substantially uniform pressure. In some embodiments, substantially uniform pressure results in a pressure variance across the face of the cells of not more than about +/−20 psi. In other embodiments, substantially uniform pressure may vary by only about +/−13 psi across the face of the cells, and in some cases by as little as +/−5 psi. As further illustrated in FIGS. 5A and 5B, battery discharge capacity is substantially maintained over a cycle life approaching 300 charge/discharge cycles uniform, and constant cell face pressure is maintained within the critical range as explained above for cells at load levels of about 25 mg/cm² to about 31 mg/cm². As is understood in the art, the load level refers to the amount of cathode active material per area. Assuming the footprint (length×width) remains the same, then the load level varies with the depth (thickness) of the cathode (outer surface to current collector).

The battery packs according to the present disclosure may optionally include compliant pads placed between each of the cells or between select cells, such as between the first and second cells, and third and fourth cells of a four-cell stack for example. A compliant pad is a spacer intended to distribute the cell expansion pressure evenly during charging and pushes back to the cell during discharging. In a further alternative, a cooling pad may be placed between select cells to help dissipate heat, such as between the second and third cells in the four-cell stack example. In general, the X-Y dimensions of compliant pads may correspond to the dimension of cells, while the thickness of the compliant pad is determined by the expansion extent of the cell and is optimized between the variables of allowed battery pack volume and durometer rating of the pad to control cell-face pressure at the desired level, e.g., at or above 200 psi as elsewhere described herein. In one example, the compliant pad may be made of polyurethane sheet with a dimension of approximately 2.8 inches×1.8 inches, with a thickness of approximately 0.625 inches, and such pad may allow a cell expansion of 20%. Examples of suitable polyurethane sheet properties are provided in Table 1 below.

TABLE 1

| | Durometer Shore | | | |
|---|---|---|---|---|
| | 40 | 60 | 80 | 90 |
| | A | A | A | A |
| 100% Modulus, psi (Mpa) | 130 (0.89) | 220 (1.52) | 600 (4.1) | 1100 (7.6) |
| 300% Modulus, psi (Mpa) | 270 (1.86) | 460 (3.17) | 1000 (6.9) | 2200 (15.2) |
| Tensile Strength, psi (Mpa) | 840 (5.79) | 4100 (28.2) | 6700 (46.2) | 5500 (37.9) |
| Elongation % | 490 | 490 | 660 | 430 |
| Die C Tear, pli (kN/m) | 130 (22.8) | 200 (35) | 475 (83.1) | 700 (123) |
| Bashore Resilience % | 37 | 22 | 31 | 40 |
| Compression Set, Method B, | 10 | 2 | 29 | 36 |
| 22 hrs @ 158° F. | | | | |
| Compression Modulus, psi (Mpa) | | | | |
| 5% | 20 (0.14) | 30 (0.21) | 220 (1.5) | (not given) |
| 10% | 30 (0.21) | 40 (0.28) | 330 (2.3) | |
| 15% | 38 (0.26) | 55 (0.38) | 390 (2.7) | |
| 20% | 46 (0.32) | 70 (0.48) | 520 (3.6) | |
| 25% | 55 (0.38) | 115 (0.79) | 670 (4.6) | |
| Specific Gravity | 1.22 | 1.24 | 1.25 | 1.13 |

The cooling pad may comprise a thin sheet of metal with a high thermal conductivity, such as copper or aluminum. Heat may be dissipated radiantly, for example, by exposure of an edge of the cooling pad to ambient conditions or by attachment to a heat sink. Alternatively, the cooling pad may comprise a sheet of material provided with small passages for circulation of cooling fluid therein.

In one alternative embodiment, a rechargeable battery pack according to the present disclosure may employ five compliant pads, each being sandwiched between cells 114 and/or between the cell 114 and one of plates 104, 106 of the housing structure 100. In one example of this alternative embodiment, the compliant pad is approximately 58 mm in length and 48 mm in width. Each compliant pad has an approximate 3.175 mm (0.125 inches) thickness. Similarly, the pad may be made of a polyurethane sheet material with a smooth surface texture and material properties as identified above in Table 1. The five-pad embodiment described herein may provide a cell with a gravimetric energy density of >350 Wh/Kg and volumetric energy density of >590 Wh/L at 30% SoC (state of charge).

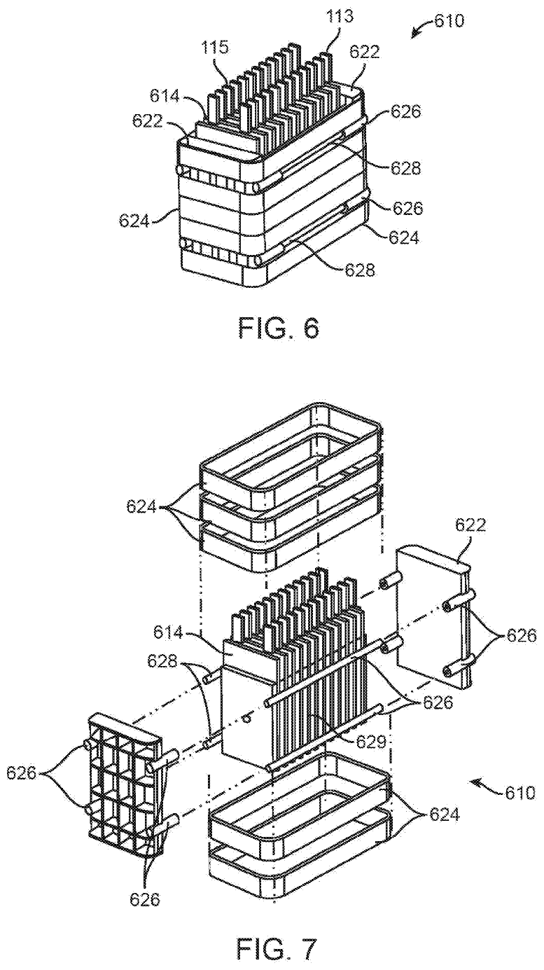

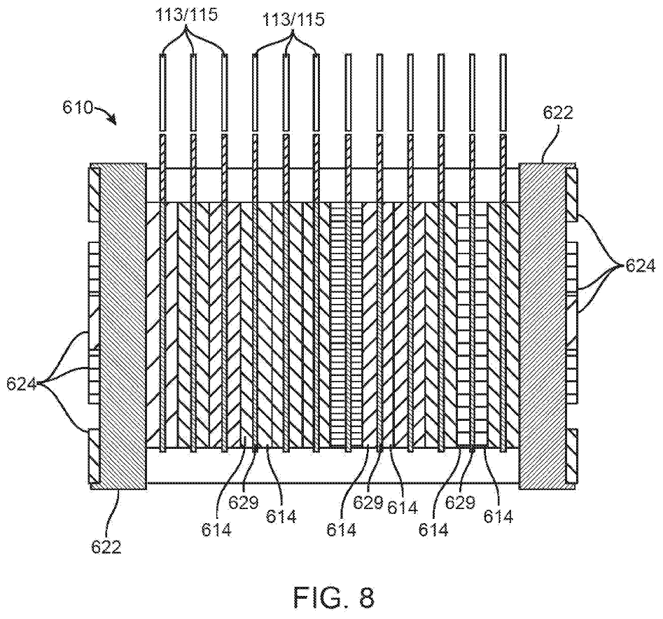

Turning to FIGS. 6, 7 and 8, in a further alternative embodiment, battery pack 610 comprises plural cells 614 formed as described above. In the illustrated example twelve cells, constrained between a pair of end plates 622 are provided, however, more or less cells may be provided. One or more linear or constant force biasing members 624 cause endplates 622 to apply continuous constraining force to the stack of cells 614. The elastic members 624 may store energy when the battery is being charged (expanding) and constantly maintains a selected compression force between the pair of end plates 622 as described above. Biasing members 624 are selected to apply an at least substantially constant force on the endplates 622 that results in the critical uniform and at least substantially constant cell surface pressure of above at least 100 psi and more preferably above at least about 200 psi, wherein, in some embodiments, the uniform and substantially constant pressure applied will be a pressure between about 100-500 psi, and more preferably between about 200 psi and 300 psi, as previously explained.

In order to maintain a substantially even surface pressure across cell faces during expansion and contraction, the end plates 622 are each provided with four collars 626, two on each side in the length direction. Each collar 626 is provided with a hole to closely accommodate a guide member 628 inserted therein. The guide member 628 may slide into the hole of the collar 626 and achieve a clearance fit therebetween. This may limit the expansion in width direction and apply evenly distributed pressures on both sides of the battery pack 610. The length of the collar 626 is sized to be sufficient to resist binding or excessive friction with the guide member 628 if eccentric loads are experienced in expansion or contraction of the cell stack. For example, in one example, the guide member 628 is constructed of composite epoxy resin structure with a tensile strength of 600 kpsi, modulus of elasticity of 34 Mpsi. In this example, the guide member may be about 3.70 inch (94 mm) in length and weigh about 1.2 grams.

The foregoing has been a detailed description of illustrative embodiments of the disclosure. It is noted that in the present specification and claims appended hereto, conjunctive language such as is used in the phrases “at least one of X, Y and Z” and “one or more of X, Y, and Z,” unless specifically stated or indicated otherwise, shall be taken to mean that each item in the conjunctive list can be present in any number exclusive of every other item in the list or in any number in combination with any or all other item(s) in the conjunctive list, each of which may also be present in any number. Applying this general rule, the conjunctive phrases in the foregoing examples in which the conjunctive list consists of X, Y, and Z shall each encompass: one or more of X; one or more of Y; one or more of Z; one or more of X and one or more of Y; one or more of Y and one or more of Z; one or more of X and one or more of Z; and one or more of X, one or more of Y and one or more of Z.

Various modifications and additions can be made without departing from the spirit and scope of this disclosure. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present disclosure. Additionally, although particular methods herein may be illustrated and/or described as being performed in a specific order, the ordering is highly variable within ordinary skill to achieve aspects of the present disclosure. Accordingly, this description is meant to be taken only by way of example, and not to otherwise limit the scope of this disclosure.

Exemplary embodiments have been disclosed above and illustrated in the accompanying drawings. It will be understood by those skilled in the art that various changes, omissions and additions may be made to that which is specifically disclosed herein without departing from the spirit and scope of the present disclosure.

1. A battery core pack, comprising:
a plurality of cells forming a cell stack, each cell comprising at least one anode and at least one cathode, wherein metal ions are stripped from the anode during discharge and re-plated on the anode during charge; and
a containment structure at least partially surrounding the cell stack, wherein said containment structure imparts an at least substantially uniform and constant surface pressure of at least 200 psi to the cells of said cell stack.

2. The battery core pack of claim 1, wherein the substantially uniform surface pressure is within a range of about 200 psi to about 300 psi.

3. The battery core pack of claim 3, wherein the cathode is a layered or spinel oxide material of the general formula of LiₓM_{y}O_{z}, where M is a transition metal comprising Co, Mn, Ni, V, Fe, or Cr.

4. The battery core pack of claim 1, wherein each cell contains an electrolyte, the electrolyte comprising one or more lithium salts selected from the group consisting of lithium bis(fluorosulfonyl)imide, lithium bis(trifluoromethanesulfonyl)imide, lithium hexafluorophosphate, lithium bis(oxalato)borate, lithium difluoro(oxalato)borate, lithium perchlorate, and lithium tetrafluoroborate.

5. The battery core pack of claim 4, wherein the lithium salt comprises at least lithium bis(fluorosulfonyl)imide.

6. The battery core pack of claim 4, wherein the lithium salt is present in a concentration range from 0.1 M to 8.0 M.

7. The battery core pack of claim 6, wherein the lithium salt is present in a concentration range from 1.5 M to 4.5 M.

8. The battery core pack of a e claim 1, wherein said cells maintain a discharge capacity of greater than 2.5 Ah over at least 100 charge/discharge cycles.

9. The battery core pack of claim 1, comprising at least four cells with a core pack energy density of at least about 590 Wh/L at 30% SoC.

10. The battery core pack of claim 1, wherein said anode comprises lithium metal.

11. A battery core pack, comprising:
a cell stack comprised of at least four cells with a core pack energy density of at least about 590 Wh/L at 30% SoC and a discharge capacity of greater than 2.5 Ah over at least 100 charge/discharge cycles, each said cell having a load level of about 25 mg/cm² and to about 31 mg/cm², and comprising at least one cathode formed as a layered or spinel oxide material of the general formula of LiₓM_{y}O_{z}, where M is a transition metal comprising Co, Mn, Ni, V, Fe, or Cr, and at least one lithium metal anode having a thickness in the range of 10 μm-100 μm in the discharged state;
an electrolyte contained in each said cell comprising one or more lithium salts selected from the group consisting of: lithium bis(fluorosulfonyl)imide, lithium bis(trifluoromethane-sulfonyl)imide, lithium hexafluorophosphate, lithium bis(oxalato)borate, lithium difluoro(oxalato)borate, lithium perchlorate, and lithium tetrafluoroborate, wherein the lithium salt is present in a concentration range from 0.1 M to 8.0 M; and
a containment structure at least partially surrounding the cell stack, wherein said containment structure imparts an at least substantially uniform and constant surface pressure within a range of about 200 psi to about 300 psi to the cells of said cell stack.

12. The battery core pack of claim 11, wherein the electrolyte further contains one or more solvents selected from the group consisting of linear carbonates; cyclic carbonates; linear ethers; cyclic ethers, esters, sulfonyl and phosphate.

13. The battery core pack of claim 12, wherein each solvent is present in a concentration ranging from 100% to 0.2% by volume or by weight or by mole ratios.

14. The battery core pack of claim 12, wherein the linear carbonates are selected from the group consisting of: dimethyl carbonate, diethyl carbonate, and ethylmethyl carbonate.

15. The battery core pack of claim 14, wherein the linear carbonate is one or a combination of dimethyl carbonate or ethylmethyl carbonate.

16. The battery core pack of claim 12, wherein the cyclic carbonates are selected from the group consisting of: ethylene carbonate, propylene carbonate, fluoroethylene carbonate, and vinylene carbonate.

17. The battery core pack of claim 16, wherein the cyclic carbonates is one or a combination more than one of ethylene carbonate, propylene carbonate, or vinylene carbonate.

18. The battery core pack of claim 12, wherein the linear ethers are selected from the group consisting of: methyl propyl ether, methyl butyl ether, ethyl propyl ether, ethyl butyl ether, propyl butyl ether, diethyl ether, dipropyl ether, and dibutyl ether, 1,2-diethoxy ethane, 1,2-dimethoxy ethane, 1,2-dipropoxyethane, and 1,2-dibutoxyethane, bis(2-methoxyethyl) ether, 2-ethoxyethyl ether, 1,2-(1,1,2,2-tetrafluoroethoxy)ethane, and 1,1,2,2-tetrafluoroethyl 2,2,3,3-tetrafluoropropyl ether.

19. The battery core pack of claim 12, wherein the cyclic ethers are selected from the group consisting of: 1,3-dioxolane, 1,4-dioxane, 1,3-dioxane, tetrahydropyran, tetrahydrofuran, 2,4-dimethyltetrahydrofuran, 2-methyltetrahydrofuran, 3-methyltetrahydrofuran, and 2-ethyl-5-methyltetrahydrofuran.

20. The battery core pack of claim 12, wherein the esters are selected from the group consisting of: methyl formate, ethyl formate, methyl acetate, and ethyl acetate.

21-54. (canceled)
